(19) United States
(12) Patent Application Publication
(10) Pub. No.: US 2008/0163862 A1
(43) Pub. Date: Jul. 10, 2008

(54) Modular outdoor kitchen apparatus and methods

(75) Inventor: Michael E. Cartwright, Houston, TX (US)

Correspondence Address: ALTON W. PAYNE, 5508 GRAND LAKE, HOUSTON, TX, 77081, US

(73) Assignee: Outdoor Polymer Systems Inc.

(21) Appl. No.: 11/649,129

(22) Filed: Jan. 4, 2007

(51) Int. Cl. A47J 37/07

(52) U.S. Cl. 126/25 R; 29/458

(57) ABSTRACT

A unitary kitchen assembly and method is provided. A method comprises the steps of tooling an expanded polystyrene member to have circumferential surfaces and recessed surfaces, the recessed surfaces comprising a compartment for accepting a stove element, insulating the compartment in the expanded polystyrene member such that the stove element is sufficiently insulated with respect to the compartment to protect the heat integrity of the member at temperatures that the stove element operates, and providing at least one of structural load points or a urethane/quartz aggregate exterior coating for supporting the expanded polystyrene member for providing structural integrity to the member such that the member can receive weighted objects thereupon without compromising the structural integrity of the expanded polystyrene member. A unitary kitchen assembly is provided comprising an expanded polystyrene member comprising a plurality of circumferential surfaces having a plurality of extremities remote one from the other, a plurality of interior surfaces, the interior surfaces for accepting an element selected from the group consisting of shelves, refrigerators, warmers, drawers and storage spaces, and a plurality of recessed surfaces, the recessed surfaces comprising a compartment for accepting a stove element. An insulation for engaging the stove element and the compartment sufficient to protect the heat integrity of the member at temperatures that the stove element operates. And, at least one of a plurality of structural load point supports extending through the expanded polystyrene member, or a urethane/quartz aggregate exterior coating for supporting the expanded polystyrene member for providing structural integrity to the member.

### FIELD OF THE INVENTION

The present invention relates generally to a modular outdoor kitchen apparatus and associated methods. Specifically, the present invention relates to a modular outdoor kitchen enclosure or “island” having a unitary structure and a unique method of assembly. The modular outdoor kitchen enclosure is built using expanded polystyrene (“EPS”) as its core material.

### BACKGROUND OF THE INVENTION

Outdoor grilling originated after the discovery of fire when ancient man began roasting and grilling his food. There is a fascination of sorts with cooking over an open fire. Modem day outdoor grilling or “cookouts” began when small pot metal grills using wood or charcoal became available after World War II. These cookouts were simple with the menu consisting of hot dogs or hamburgers. The “chef” remained occupied while smoke, heat and bugs dominated the event. Today barbequing has become a pastime or hobby, and in some cases an art form. Grills have been transformed into formidable stainless steel appliances complete with rotisseries, smokers and warming ovens. The sophistication and cost of these appliances has escalated with top of the line grilling and barbecuing units now exceeding five thousand dollars per unit.

Barbeque enclosures or “Islands” have emerged into elaborate and expensive cabinets that include all of the amenities available to there indoor cousins. Construction of basic built-in outdoor cabinetry exceeds three hundred dollars per linear foot. Concrete masonry units, treated lumber and hardy plank siding are the most commonly used materials. Construction methods vary; however, most builders employ a “sticks and bricks” method of construction. Similar to constructing a small room addition, assembly of an outdoor kitchen is time consuming, cumbersome and expensive. Although some manufacturers produce kitchen “kits” utilizing metal studs and hardy siding, installation requires craftsmen from several trade groups to complete. Frustrations with the current process led us to the need for a modular system that is ergonomic in design, lightweight, durable and easy to install.

The outdoor kitchen market in the United States was approximately $9 billion dollars in 2004 and has been increasing consistently each year. It is the major component of a trend to re-create the backyard of people's homes into additional “outdoor rooms” in which they entertain and enjoy as if they were inside. There is a specific need for custom designed kitchens that range from 4 feet to 20 feet plus in length. An average outdoor kitchen is approximately 7 feet and would sell retail for approximately $3,000 to $10,000 or more depending on the type and quality of appliances installed in it. The outdoor kitchen business has become a “big ticket” item, much like an automobile. Outdoor kitchens can be financed with the construction of a home, a home remodeling or other forms of long-term property collateralized lending. Often these kitchens are purchased at the time of a pool purchase or back-yard remodeling.

Many companies provide products directed to the outdoor kitchen marketplace. In the market for outdoor cooking products, there exist some costly and inconvenient enclosure systems which are merely cabinetry. Such companies produce outdoor appliances available to consumers for outdoor grilling, refrigeration and serving. As is common in outdoor kitchen design, cabinetry serves aesthetic as well as a functional purpose.

What is needed is a product that substitutes the typical methods used in constructing outdoor cabinetry. Such a product line would significantly reduce the man-hours involved in the construction and installation of these kitchens. Further, systems are needed that remain adaptable to individual needs, are lightweight, durable, and constructed from user-friendly materials. These ergonomically designed products would assist installers and builders in “value-added reselling” (VAR) with significant profit potential to the builders and value to the customers.

Traditional outdoor kitchen manufacturers have used “cookie cutter” products for custom applications with specific dimensions provided from various sources. Using costly materials to custom tailor these kitchen set-ups, the finished product results in a cumbersome, heavy assembly that is difficult to transport and install. However, even for a simple cabinet enclosure for a grill would cost $2,000 minimum for a cabinet 5 feet to 8 feet long, finished in stucco, with a tile countertop. In addition to assuming a large cost burden, customers may find that any error in initial appliance measurements will result in onsite installation issues increasing costs exponentially. These problems with the present market standard has initiated a drive to develop a superior product.

To enter the outdoor kitchen market, one must develop a dealer network throughout the country, such as through pool builders, home builders and BBQ retailers, to sell its custom outdoor kitchens and develop a web-based system to sell over the internet. Additionally, agreements must be made with “high-end” grill and appliance manufacturers to provide exclusive lines of outdoor kitchens for their nationwide dealer networks. The present situation provides a unique opportunity to capture a large portion of the market if someone can build and ship kitchens nationally. Unfortunately, outdoor kitchen builders can not compete nationally as kitchens must be manufactured onsite with lumber, bricks and stucco. However, if there existed a unique manufacturing method of using EPS and a special coating, kitchen units could be mass produced, crated and shipped to any location that can be reached by a trucking company.

Available for more than 20 years, expanded polystyrene or EPS is a product resembling “Styrofoam.” To date, EPS systems are utilized in the construction of commercial buildings, i.e., roofing systems, perimeter insulation, core materials for exterior wall systems, and architectural columns, trim and details. In addition the sign industry, aircraft and yacht industries, and packing systems all use EPS products. Polystyrene polymers have no nutritive value. The derived foam will not support fungus or bacterial growth and has no effect on plant or animal life. As expanded polystyrene is manufactured in many forms, strengths and densities, there are many applications for this product.

Many patents involve the use of polystyrene for various uses such as for example medical supplies. The Styrofoam-like substance is also recognized in some patents for use in electronic materials. Due to its material properties, polystyrene is applicable in many circumstances as an insulator. Many circumstances exist where packing materials use polystyrene because of its adaptability and material strength. In addition, there are many patents involving the production of microwaveable materials and food containers manufactured with polystyrene.

In some cases, patents exist within the realm of construction. U.S. Pat. No. 6,694,656 details the use of polystyrene in the assembly of interlocking frames used for display objects and/or walls. Another patent details the use of polystyrene as an insulator for composite concrete walls (See, U.S. Pat. No. 6,701,683). Other patents describe using polystyrene as insulation for domestic construction methods. An example of such as use is outlined in U.S. Pat. No. 6,701,684 in which polystyrene blocks fill vacant spaces within a common wall.

There is a great need to provide significant upgrades to the current crop of outdoor kitchen cabinetry. Unlike typical islands that are pieced together out of hard board and metal studs which are two materials that transfer heat, there is a need for outdoor kitchens that are built from solid blocks of EPS/expanded polystyrene that can be sprayed with a fire-retardant urethane hard-shell coating. Additionally, the traditional hardiboard kitchen units are limited in their design capabilities, and commonly have open interiors and no solid base. There is a need for solid, unitary structures in which cut-outs are created for appliances (i.e., grills, side burners) and accessories (i.e., storage doors, sinks). The cut-outs or cavities have finished interiors that are completely enclosed and waterproof. There is a need for an enclosure having a modular system for providing virtually limitless configurations that are easily adaptable to job site conditions.

It is, therefore, a feature of the present invention to provide a modular outdoor kitchen apparatus and methods that in normal use provide enhanced features and characteristics over those known.

A feature of the present invention is to provide an outdoor cabinet enclosure system that significantly reduces the man-hours required to construct and install an outdoor kitchen.

Another feature of the present invention is to provide a modular outdoor kitchen apparatus and methods that are adaptable to individual needs by accepting modules or removing modules as needed.

Another feature of the present invention is to provide a modular outdoor kitchen apparatus and methods that will not rot and are resistant to common household insects.

Another feature of the present invention is to provide a modular outdoor kitchen apparatus and methods that are shipped pre-assembled and available in multiple finishes.

Yet another feature of the invention is to provide a modular outdoor kitchen apparatus and methods that allows machining steps to proceed accurately without human intervention or human error.

Still another feature of the present invention is utilizing a modular outdoor kitchen apparatus and methods that has grill cavities that include built-in fire protection as a standard feature, rather than an option or upgrade.

Another feature of the present invention is to provide a modular outdoor kitchen apparatus and methods that have a grill cavity adapted to assist in heat transfer.

Yet another feature of the present invention is to provide a modular outdoor kitchen apparatus and methods that have quartz aggregate particles added to a hard-shell coating, which provides further rigidity and allows for the necessary rough texture that various aesthetic materials can adhere to.

Yet another feature of the present invention is to provide a modular outdoor kitchen apparatus and methods that have surfaces that are impact resistant for accepting infinite combinations of aesthetic materials including, by way of example, stucco, polymer, wood, concrete, tile, slate and flagstone.

Still another feature of the present invention is to provide a modular outdoor kitchen apparatus and methods that has a unique combination of materials including, for example, polystyrene, high-performance urethane coatings, heat resistant materials and aesthetic materials.

Yet still another feature of the present invention is to provide a modular outdoor kitchen apparatus and methods that provides continuous cross ventilation.

Yet further, an additional feature of the present invention is a modular outdoor kitchen apparatus and methods that provides unlimited configurations.

Yet further, another feature of the present invention is a modular outdoor kitchen apparatus and methods that provides pre-plumbed gas chases and multiple electrical chases.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, a unitary kitchen assembly and methods of fabrication are defined.

A method of fabricating a unitary kitchen assembly suitable for use outdoors comprises the steps of tooling an expanded polystyrene member to have circumferential surfaces and recessed surfaces, the recessed surfaces comprising a compartment for accepting a stove element, insulating the compartment in the expanded polystyrene member such that the stove element is sufficiently insulated with respect to the compartment to protect the heat integrity of the member at temperatures that the stove element operates, and providing at least one of structural load points or a urethane/quartz aggregate exterior coating for supporting the expanded polystyrene member for providing structural integrity to the member such that the member can receive weighted objects thereupon without compromising the structural integrity of the expanded polystyrene member, such that the unitary kitchen assembly is adaptable to be placed in outdoor environments.

Another method of fabricating a unitary kitchen assembly suitable for use outdoors comprises the steps of tooling an expanded polystyrene member to have a plurality of circumferential surfaces, a plurality of interior surfaces and a plurality of recessed surfaces, the recessed surfaces comprising a compartment for accepting a stove element and the interior surfaces for accepting an element selected from the group consisting of shelves, refrigerators, warmers, drawers and storage space, insulating the compartment in the expanded polystyrene member such that the stove element, upon acceptance in the compartment, is sufficiently insulated with respect to the compartment to protect the heat integrity of the member at temperatures that the stove element operates, and at least one of the steps of (1) supporting the expanded polystyrene member with a plurality of elongated structural load point studs or (2) coating the exterior of the member with a urethane/quartz aggregate for providing structural integrity to the member such that the member can receive weighted objects thereupon without compromising the structural integrity of the expanded polystyrene member, such that the steps of tooling, insulating, supporting, and/or coating result in a unitary kitchen assembly adaptable to be placed in outdoor environments.

A unitary kitchen assembly is provided comprising an expanded polystyrene member comprising a plurality of circumferential surfaces having a plurality of extremities remote one from the other, a plurality of interior surfaces, the interior surfaces for accepting an element selected from the group consisting of shelves, refrigerators, warmers, drawers and storage spaces, and a plurality of recessed surfaces, the recessed surfaces comprising a compartment for accepting a stove element. An insulation for engaging the stove element and the compartment sufficient to protect the heat integrity of the member at temperatures that the stove element operates. And, at least one of (1) a plurality of structural load point supports extending through the expanded polystyrene member for providing structural integrity to the member, or (2) a urethane/quartz aggregate exterior coating for supporting the expanded polystyrene member for providing structural integrity to the member such that the member can receive weighted objects thereupon without compromising the structural integrity of the expanded polystyrene member, whereby the unitary kitchen assembly is adaptable to be placed in outdoor environments.

For the unitary kitchen assembly defined above, the insulation for engaging the stove element and the compartment sufficient to protect the heat integrity of the member at temperatures that the stove element operates comprises a first insulating partition for engaging the stove element, a second insulating partition for engaging the member, and an intermediate insulating partition congruent with the compartment for engaging the first insulating partition and the second insulating partition sufficient to protect the heat integrity of the member at temperatures that the stove element operates.

Also, for the unitary kitchen assembly defined herein, the structural load point supports extend through the expanded polystyrene member resulting in a plurality of stanchions engaged with the extremities of the members for providing the uniform support and distribution of the weight of any object placed on any member such that the member can receive weighted objects thereupon without compromising the structural integrity of the expanded polystyrene member.

Further, for the unitary kitchen assembly defined herein, the urethane/quartz aggregate exterior coating for supporting the expanded polystyrene member for providing structural integrity to the member comprises a diisocyanate diphenylmethane and a hydroxy polyol proportionately mixed and catalyzed into a spray. The spray is applied simultaneously while broadcasting a quartz aggregate for providing the uniform support and distribution of the weight of any object placed on the member. Therefore, the member can receive weighted objects thereupon without compromising the structural integrity of the expanded polystyrene member.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a perspective view of a preferred embodiment of a unitary kitchen assembly encompassed by the present invention with accessories included.

FIG. 2 is an exploded view of the oven enclosure as illustrated in FIG. 1 illustrating the relationship of the various components of one embodiment of the oven enclosure encompassed by the present invention.

FIG. 3 is a perspective view of a preferred embodiment of a universal left-side enclosure encompassed by the present invention.

FIG. 4 is a perspective view of a preferred embodiment of a universal right-side enclosure encompassed by the present invention.

FIG. 5 is a perspective view of a preferred embodiment of a universal sink enclosure encompassed by the present invention.

FIG. 6 is a perspective view of a preferred embodiment of a support member in association with an enclosure as encompassed by the present invention.

FIG. 7 is a perspective view of another preferred embodiment of a support member in association with an enclosure with a surface coating applied as encompassed by the present invention.

FIG. 8 is a perspective, cut-away view of a preferred embodiment of a support member in association with a graduated surface mount assembly as encompassed by the present invention.

FIG. 9 is a perspective, cut-away view of a preferred embodiment of a support member in association with a mobile surface mount assembly as encompassed by the present invention.

FIG. 10 is a perspective view of a preferred embodiment of a unitary kitchen assembly encompassed by the present invention without the accessories.

FIG. 11 is a flow chart illustrating a preferred embodiment of a method of the unitary kitchen assembly encompassed by the present invention.

FIG. 12 is a flow chart illustrating another preferred embodiment of a method of the unitary kitchen assembly encompassed by the present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

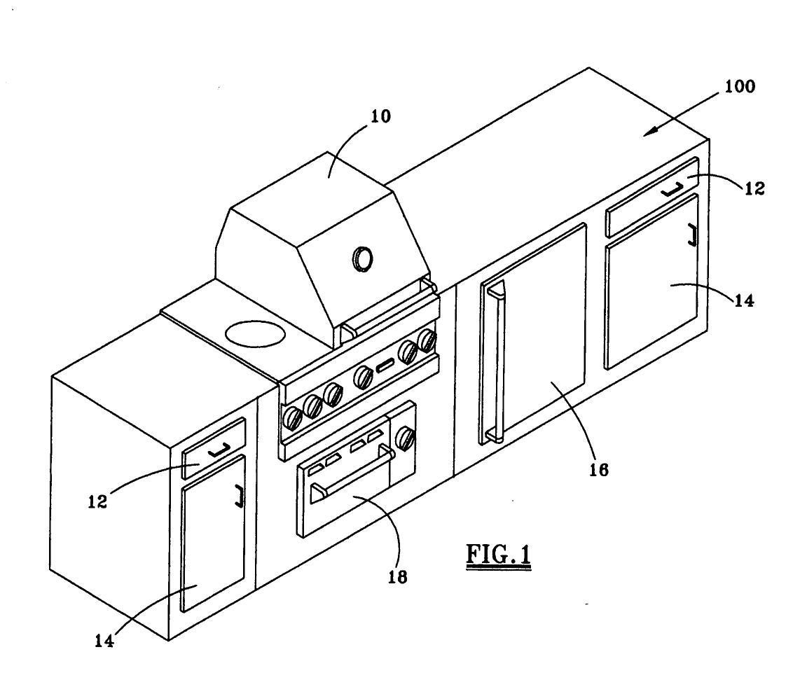

FIG. 1 is a perspective view of a preferred embodiment of a unitary kitchen assembly 100 encompassed by the present invention with the accessories included. The unitary kitchen assembly 100 is illustrated with a stove 10, drawers 12, cabinets 14, a refrigerator 16 and a warmer/oven 18. It can be appreciated by those skilled in the art that various and sundry other and different accessories can be added to or implemented with the unitary kitchen assembly 100 of the present invention, and, all such accessories are within the scope of the present invention.

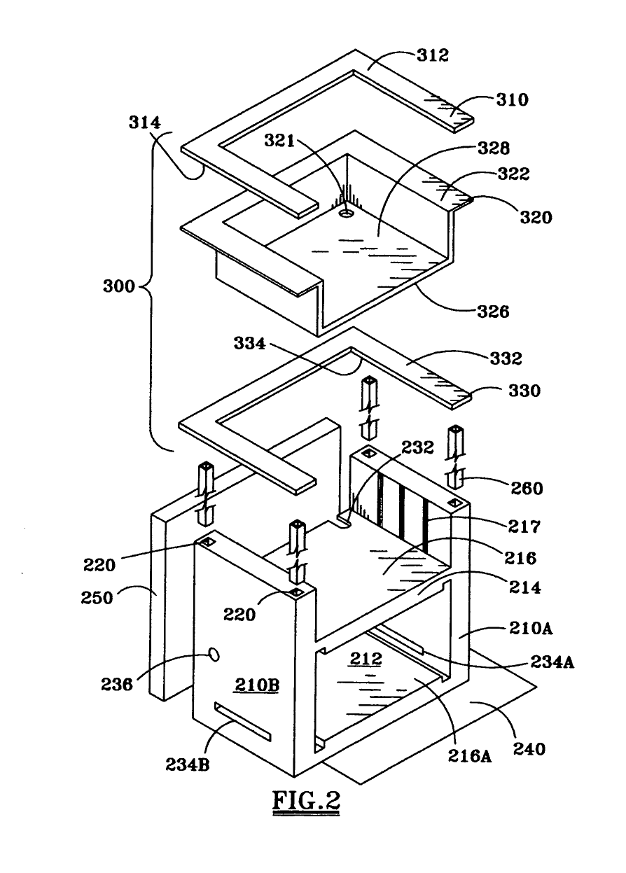

FIG. 2 is an exploded view of the oven enclosure 200 as illustrated in FIG. 1 illustrating the relationship of the various components of one embodiment of the oven enclosure 200 encompassed by the present invention. The oven enclosure 200 generally comprises a pair of sides 210A, 210B, a bottom 212, a partition 214, a back member and a cement/fibre board base 240. The partition 214 and the extremities of the sides 210A, 210B form the compartment 216. Similarly, the partition 214, the bottom 212 and the sides 210A, 210B form an auxiliary compartment 216A. The channels 220 accept the supports 260 throughout the length of the enclosure 200. The enclosure 200 is adapted for receiving conduits for electrical, gas, communication and the like. Particularly, gas chase 232 and chase 236 are illustrated in FIG. 2.

Also illustrated in FIG. 2 is the insulation 300. The insulation 300 comprises a first insulation panel 310, an intermediate insulation partition 320 and a second insulation panel 320. The first insulation panel 310 has an upper surface 312 and a lower surface 314. The second insulation panel 330 has an upper surface 332 and a lower surface 334. The insulation partition 320 has an upper surface 322, a lower surface 324, a concaved portion 328 and a convexed portion 326. Within the concaved portion is a chase 311 that coincides with the chase 232 in the oven enclosure 200 for accepting conduit there through.

FIG. 3 is a perspective view of a preferred embodiment of a universal left-side enclosure 400 encompassed by the present invention. The universal left-side enclosure 400 has a side 410, a bottom 412, a top 414 and a back 450. The side 410 has a vent 434 that is symmetrical with respect to any adjacent vents. The top 414 of the left-side enclosure 400 has therein a receptacle chase 418.

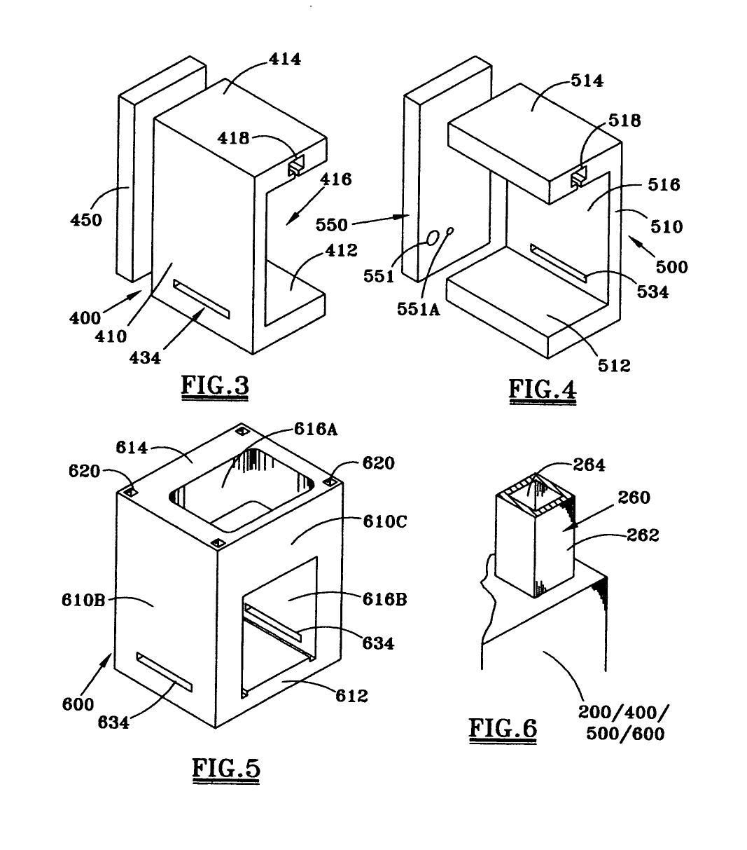

FIG. 4 is a perspective view of a preferred embodiment of a universal right-side enclosure 500 encompassed by the present invention. The universal right-side enclosure 500 has a side 510, a bottom 512, a top 514 and a back 550. The side 510 has a vent 534 that is symmetrical with respect to any adjacent vents. The top 514 of the left-side enclosure 500 has therein a receptacle chase 518.

FIG. 5 is a perspective view of a preferred embodiment of a universal enclosure 600 encompassed by the present invention. The universal enclosure 600 has the sides 610A, 610B, 610C, 610D, the bottom 612 and the top 614. The top 614 is configured to form a first compartment 616A. And, a second compartment 616B is formed by the arrangement of the sides 610A, 610B, 610C, 610D, the bottom 612 and the top 614. The sides 610A, 610B have the vents 634 that are symmetrical with respect to any adjacent vents.

FIG. 6 is a perspective view of a preferred embodiment of a support member 260 in association with an enclosure 200, 400, 500, 600 as encompassed by the present invention. The support 260 has an exterior surface 262 and an interior surface 264. The support 260 is engaged throughout the enclosure 200, 400, 500, 600 to ensure that the enclosure 200, 400, 500, 600 is sufficiently strong.

FIG. 7 is a perspective view of another preferred embodiment of a support member 260 in association with an enclosure with a surface coating 720 applied as encompassed by the present invention. The enclosure 200, 400, 500, 600 is sprayed with an epoxy layer 710 that has enmeshed therewith a surface texture 720.

FIG. 8 is a perspective, cut-away view of a preferred embodiment of a support member 260 and enclosure 200, 400, 500, 600 in association with a graduated surface mount assembly 810 as encompassed by the present invention.

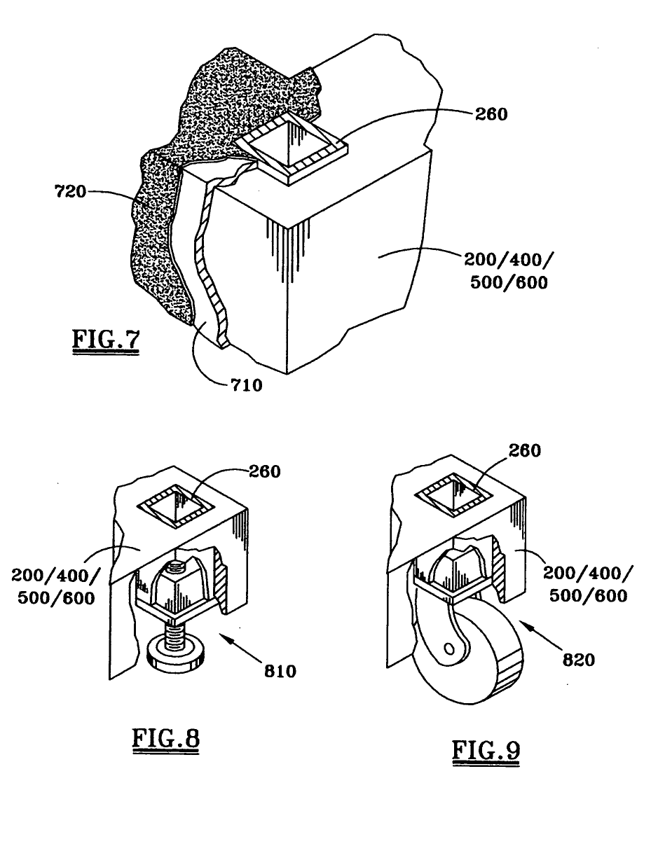

FIG. 9 is a perspective, cut-away view of a preferred embodiment of a support member 260 and enclosure 200, 400, 500, 600 in association with a mobile surface mount assembly 820 as encompassed by the present invention.

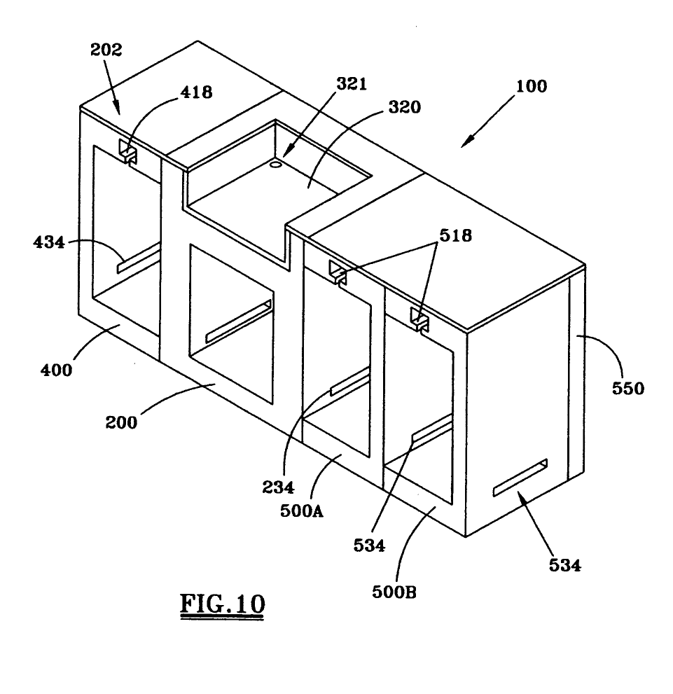

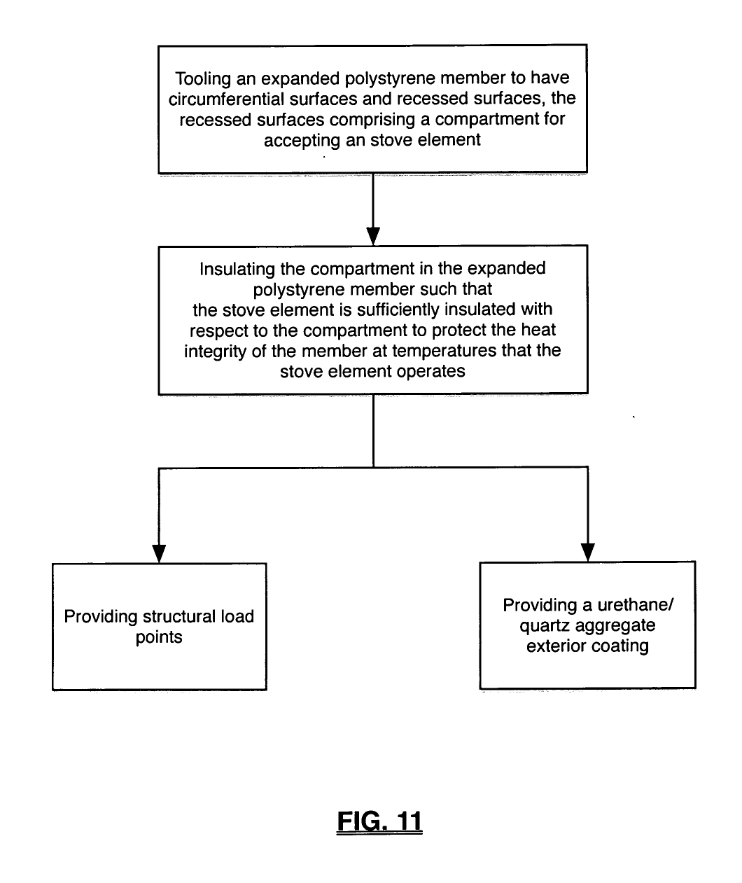

FIG. 10 is a perspective view of a preferred embodiment of a unitary kitchen assembly 100 encompassed by the present invention without the accessories. The unitary kitchen assembly 100 comprises an oven enclosure 200, two right-hand enclosures 500A, 500B and a left-hand enclosure 400. The two right-hand enclosures 500A, 500B and the left-hand enclosure 400 have receptacle chases 518, 418. A countertop 202 is illustrated. Further, the symmetrical vents 534, 234, 434 are illustrated throughout the length of the unitary kitchen assembly 100.

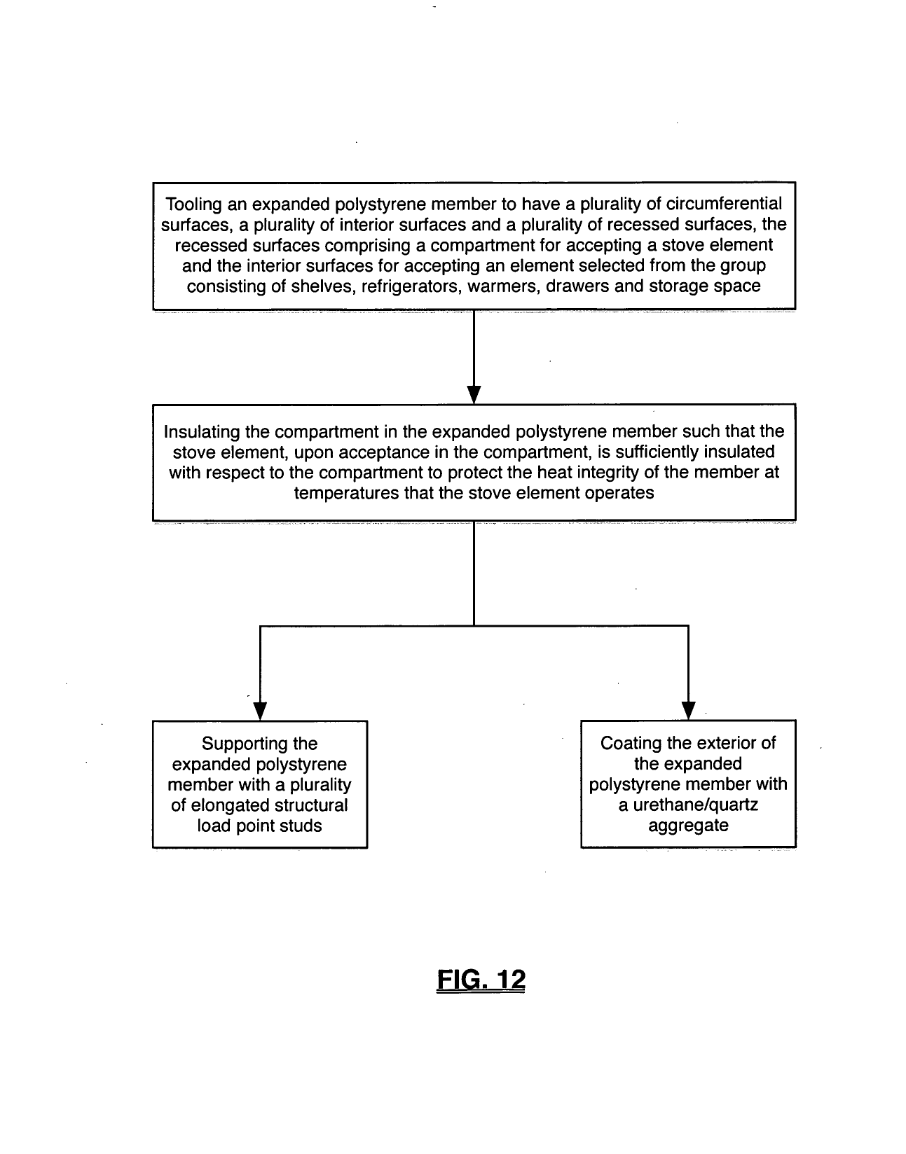

FIG. 11 is a flow chart illustrating a preferred embodiment of a method of the unitary kitchen assembly encompassed by the present invention. A method of fabricating a unitary kitchen assembly suitable for use outdoors comprises the steps of tooling an expanded polystyrene member to have circumferential surfaces and recessed surfaces, the recessed surfaces comprising a compartment for accepting a stove element, insulating the compartment in the expanded polystyrene member such that the stove element is sufficiently insulated with respect to the compartment to protect the heat integrity of the member at temperatures that the stove element operates, and providing at least one of structural load points (SLP's) and a urethane/quartz aggregate exterior coating for supporting the expanded polystyrene member for providing structural integrity to the member such that the member can receive weighted objects thereupon without compromising the structural integrity of the expanded polystyrene member, such that the steps of tooling, insulating and providing support result in a unitary kitchen assembly adaptable to be placed in outdoor environments.

FIG. 12 is a flow chart illustrating another preferred embodiment of a method of the unitary kitchen assembly encompassed by the present invention. Another method of fabricating a unitary kitchen assembly suitable for use outdoors comprises the steps of tooling an expanded polystyrene member to have a plurality of circumferential surfaces, a plurality of interior surfaces and a plurality of recessed surfaces, the recessed surfaces comprising a compartment for accepting a stove element and the interior surfaces for accepting an element selected from the group consisting of shelves, refrigerators, warmers, drawers and storage space, insulating the compartment in the expanded polystyrene member such that the stove element, upon acceptance in the compartment, is sufficiently insulated with respect to the compartment to protect the heat integrity of the member at temperatures that the stove element operates, and at least one of supporting the expanded polystyrene member with a plurality of elongate studs (SLP's) and coating the exterior of the member with a urethane/quartz aggregate for providing structural integrity to the member such that the member can receive weighted objects thereupon without compromising the structural integrity of the expanded polystyrene member, such that the steps of tooling, insulating, supporting and/or coating result in a unitary kitchen assembly adaptable to be placed in outdoor environments.

Typically, the enclosures 200, 400, 500, 600 are fabricated from expanded polystyrene using Cad/Cam CNC-based hot-wire technology. Polystyrene blocks are cut to exact dimensions, i.e., within millimeters of required dimensions. Also, Computer Numeric Control, (CNC) allows machining steps to proceed accurately without human intervention or variability.

The Structural Load Point (SLP) supports 260 are then incorporated into each of the enclosures 200, 400, 500, 600. The supports 260 are inserted into the precut channels 220, 420, 520, 620. These structural supports 260 sustain 100% of the weight of any countertop surface 202 in addition to the weight of any appliance such as the stove 10, the refrigerator 16, the warmer/oven 18, drawers 12, cabinets 14 and the like. The SLP supports 260 protect the enclosures 200, 400, 500, 600 from any deformation due to weight loading and/or seasonal weather changes. The grill cavity or compartment 216 is fireproofed using the UniBarrier™ Grill Cavity Protection System. The UniBarrier™ Grill Cavity Protection System is comprised of ½″ calcium silicate board and 1½″-8 lb. density mineral wool. The combination of the calcium silicate board and the dense mineral wool is capable of withstanding temperatures of up to 3,000 degrees Fahrenheit. Unique in design, the UniBarrier™ Grill Cavity Protection System 320 reflects heat and transfers the heat away from the grill cavity or compartment 216. In addition, the cavity or compartment 216 has vertically corrugated sides 217 to assist in heat transfer. The vertically corrugated sides 217 work in conjunction with the grill or stove 10 allowing heat to dissipate as opposed to being stored in the cavity or compartment 216.

Once formed, the exterior of the enclosures 200, 400, 500, 600 are coated in a polyurethane coating 710 using, for example, a plural sprayer. Once the polyurethane coating 710 is applied, the structural integrity of the EPS is impact resistant. The polyurethane coating 710 dries instantly and accepts infinite combinations of aesthetic materials 720 that provide numerous and sundry surface textures. The aesthetic materials 720 are applied to the exterior of the enclosures 200, 400, 500, 600 and include stucco, wood, concrete, tile, granites and the like. The resulting product boasts excellent ergonomics, reduced production costs, attractive retail price points, and infinite applications. The unitary kitchen assemblies 100 can be custom configured to any specifications.

Polystyrene is a structural component for the unitary kitchen assemblies 100. Some inherent properties of polystyrene include strength, fabrication, handling, adaptability and low cost. Typically, the polystyrene material will be used as the main forming component for the unitary kitchen assembly 100. Hot wire cutting machines custom tailor the polystyrene to specific dimensions and designs. Typically, a Grade 71, type 5371 polystyrene is used due to its excellent fit for this specific application. Sometimes denoted as bead size “B,” this designation of polystyrene boasts the following qualities:

| | |
|---|---|
| Unexpanded particle size (mm): | 0.700–1.100 |
| Density Range (lbs/cubic foot): | 1.5–3.0. |

However, it can be appreciated by one skilled in the art that any component having the physical characteristics of polystyrene would be adaptable for use with the present invention, and would fall within the scope of the present invention.

For the purpose of shielding heat from the core structure, fire-retardant additives are blended into the proprietary polyurea hard-shell coating, which tolerates temperatures of up to 2,000 degrees Fahrenheit. In addition, the aforementioned UniBarrier™ Grill Cavity Protection System is able to withstand temperatures of up to 3,000° F., which is far beyond anything the grill or stove 10 could feasibly produce. Also, the unitary kitchen assemblies 100 can be readily adapted to use protective coatings such as for example flexible ceramic composites (PCC). Certain PCC's can withstand the heat from an oxyacetylene torch with little damage. PCC coatings do an excellent job of preventing heat from transferring to the underlying material.

To achieve superior surface rigidity, a proprietary hard-shell urethane coating (aka the “UniShell™ coating”) is sprayed onto the finalized kitchen assembly. An additional component of the UniShell™ coating is the quartz aggregate which can be simultaneously sprayed onto the UniShell™ enclosures, providing further rigidity and allowing for the necessary rough texture that various aesthetic materials can adhere to. The UniShell™ coating is a rapid-setting coating with the following characteristics:

| | |
|---|---|
| Tensile Strength: | 2,122 psi |
| Specific Gravity: | 1.07–1.23 |
| Weight (Gal/Ibs): | 8.94–10.28 |
| Set time: | 8 seconds with continued hardening |
| | over a 12-hour period. |

With sufficient tensile strength, the StyroSpray 715 coating results in a extremely strong, durable surface. Having a very strong, durable surface is an important design feature of the unitary kitchen assemblies 100 to create product longevity and support the application of a variety of surface materials.

Further, polystyrene has the inherent capability of being able to accept a variety of materials for aesthetic purposes. By using polystyrene, all types of stuccos can be installed on the unitary kitchen assemblies 100 with the added benefit of a multitude of color choices. Still further, wood can be applied to the surface of the unitary kitchen assemblies 100 with infinite trim and detail options. The upper surface or the “cooking” surface also has a large number of design options. All ranges of tile shapes, sizes, and materials can be installed on the unitary kitchen assemblies 100. The combination of the above possibilities results in a huge amount of options to fully customize and individualize each unitary kitchen assembly 100.

From start to finish, the unitary kitchen assemblies 100 are designed and assembled to precise specifications. Because of the unique, automated manufacturing process, many elements of potential error are eliminated. Whereas the prior manufacture of similar products employs traditional “nail and hammer” manufacturing processes, the unitary kitchen assemblies 100 of the present invention are assembled using state of the art technology, such as for example, hot-wire cutting technology.

In modem engineering, CAD programming is standard in industry design. Typically, part of the manufacturing process includes the direct use of AutoCAD modeling techniques. AutoCAD modeling techniques allows for interactive previews to any design requested for a unitary kitchen assembly 100 as well as automated refinements to existing designs. The machine components of the manufacturing process readily accept the CAD designs as direct instructions for assembly. The manufacturing process employed to fabricate the unitary kitchen assemblies 100 achieves the ultimate level of accuracy.

For example, hot-wire cutting technology creates very smooth surfaces. Specifically, a Demand C848 hot-wire cutting machine, one of the most innovative and adaptable designs on the market, can be used. The Demand C848 hot-wire cutting machine uses 0.011″ (0.28 mm) diameter cutting wire to achieve extremely accurate and precise dimensions. The machine is capable of accepting very large blocks of polystyrene (e.g., 96″×48″×96″). Being able to accept various block sizes provides a large potential for cabinet designs. The Demand C848 hot-wire cutting machine has a fully computerized turntable as well as 6 individual drive motors controlling the cutting action. Each production cycle is fully controlled by computers eliminating human error in the manufacturing process.

For the base models of the unitary kitchen assemblies 100, there are three main parts. First, and the largest, is the main cabinet piece or the stove/oven enclosure 200. The stove/oven enclosure 200 houses the grill or stove 10, the warming drawer 18, and/or a storage cabinet 14 and a drawer 12. Second and third are the smaller enclosures for appliances such as a refrigerator 16 and others. The smaller enclosures are the left enclosure 400 and the right enclosure 500. The individual enclosures, the stove/oven enclosure 200, the left enclosure 400 and the right enclosure 500, can be oriented in any particular order as designated by the site specifications. The ability to orient the stove/oven enclosure 200, the left enclosure 400 and the right enclosure 500 in any particular order is a quality of the present invention that adds great versatility.

As previously discussed, an important issue for the unitary kitchen assemblies 100 is heat protection. The grill or oven 10 alone will put off a significant amount of heat around the contact surface. To avoid material deformation at contact points preventative measures have been adapted for use in the present invention. The unique UniBarrier™ Grill Cavity Protection System comprises a corrugated or honeycomb arrangement 217 that is precut into the polystyrene for the grill cavity or compartment 216. Once the grill 10 is inserted into the enclosure 200, the corrugated or honeycomb arrangement 217 will allow heat to vent out from the contact region as apposed to becoming trapped within the grill cavity or compartment 216 affecting the adjacent material. In addition, the application of heat resistant materials, such as a thermal coating or aluminum shield, will guard the polystyrene from any significant heat transfer. The design and fabrication features described herein insure that the heat produced by the grill 10 during even extreme operations will not plastically deform the unitary kitchen assembly 100 materials, nor allow transfer of heat to contiguous surfaces.

As previously discussed, polystyrene is capable of withstanding large loads relative to its own weight and density. For the grade of polystyrene used in practicing the present invention, loads of up to 32 psi are sustainable allowing for sufficient support to mount appliances and cooking surfaces. However, in order to achieve the ultimate level of safety and durability, the unitary kitchen assembly 100 is designed such that the polystyrene withstands virtually no load at all. The precut channels 220, 620 are engineered such that FRP Structural Load Point™ (SLP) shafts or supports 260 can be inserted running from the ground up to the countertop 702. These shafts or supports 260 will effectively buttress and support all of the material weight from all appliances as well as any mounted cooking surface. With essentially a 100% reduction in compressive loads on the polystyrene, any possible material deformation is avoided.

The unitary kitchen assembly 100 can be delivered at relatively low cost due to the light weight construction. As mentioned before, the modular design of the unitary kitchen assembly 100 allows for multiple installation possibilities. Assembly of the cabinetry would include basic configuration of the main enclosure 200, installation of the SLP shafts or supports 260, application of aesthetic materials 720, and final installation of the stove units 10, such as those manufactured by DCS, Viking, FireMagic and other manufacturers. The processes defined by the present invention will take far less time than traditional prefabricated kitchen assemblies, and will require less man power or machinery to maneuver and position the cabinetry.

The unitary kitchen assembly 100 is designed to endure extreme seasonal and climate changes. The present design provides many precautions in the fundamental design to create a durable outdoor kitchen assembly. Virtually anywhere a traditional outdoor kitchen would be installed from the already available cumbersome and expensive designs. However, the unitary kitchen assembly 100 can be used at a lower cost, with greater versatility, and better overall satisfaction. Though the core structure of the unitary kitchen assembly 100 design will be almost identical using variations of the stove/oven enclosure 200, the left enclosure 400 and the right enclosure 500, the aesthetic options allow for infinite personalization of each and every application.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

A unique coating was required to implement the present invention, and thus, the UniShell™ coating was developed. What began as a hard-shell coating for the EPS-based UniShell™ enclosures for the outdoor kitchens continued to evolve. The present UniShell™ coating was developed after numerous attempts to perfect a coating material that would replace the traditional stucco products used on the exterior of homes and buildings. Stucco, while architecturally and esthetically pleasing, provides little to no insulation, damages easily, can promote mold growth over time and is applied in multiple steps by laborers at great cost in time and materials.

It has been discovered through experimentation that a diisocyanate diphenylmethane (“MDI”) and a hydroxy polyol proportionately mixed could be catalyzed into a high pressure spray and applied simultaneously while broadcasting quartz aggregates. The UniShell™ coating material was developed as a stucco replacement. This UniShell™ coating material provides energy-efficient insulation, superior elastometric qualities for expansion and contraction due to changes in temperature, colorfastness to reduce or eliminate the impact of damaging ultra-violet rays and impact resistance to prevent damage and penetration. The UniShell™ coating is dry to the touch and hardened in 20 seconds. In subsequent modifications to improve the UniShell™ coating, it was blended with an anti-microbial to retard or eliminate mold growth and a fire-retardant to protect against temperatures up to 2,000 degrees Fahrenheit. The UniShell™ coating is a non-volatile, mostly organic, environmentally safe formulation that, while chemically “triggered” to set up and harden in 20 seconds, eliminates waiting times of hours or days when compared to traditional stucco materials. In summary, the significant benefits of the UniShell™ coating as a replacement for stucco are that it looks better, wears better, will not fade, saves money due to its energy-efficiency, fights or eliminates mold, will not bum, and best of all, is applied in a one or two-step process with application guns which save 50% to 80% of the time needed for traditional, inferior products.

The UniShell™ coating system can be used to treat not only the outdoor kitchens of the present invention, but also the exterior of commercial buildings, residential buildings as well as many industrial applications such as pipelines, tankers, truck beds, underground tanks, offshore oil and gas production and drilling platforms and numerous other possibilities.

Configurator™ Design Software for the UniShell™ Enclosures is being developed. The Configurator™ Design Software is a proprietary web-based interactive software to aid dealers, and the public, to design unique kitchen layouts. The proprietary software, called the Configurator™ is a comprehensive marketing and information tool that is only restricted by a purchaser's imagination. It is anticipated that the Configurator™ Design Software will include banner advertising for preferred grill and appliance manufacturers similar to Internet search engines. This unique software is planned to be an integral part of national market expansion.

What is claimed is:

1. A method of fabricating a unitary kitchen assembly suitable for use outdoors comprising the steps of:
(a) tooling an expanded polystyrene member to have circumferential surfaces and recessed surfaces, the recessed surfaces comprising a compartment for accepting an stove element,
(b) insulating the compartment in the expanded polystyrene member such that the stove element is sufficiently insulated with respect to the compartment to protect the heat integrity of the member at temperatures that the stove element operates, and
(c) providing at least one of structural load points and a urethane/quartz aggregate exterior coating for supporting the expanded polystyrene member for providing structural integrity to the member such that the member can receive weighted objects thereupon without compromising the structural integrity of the expanded polystyrene member,
such that the unitary kitchen assembly is adaptable to be placed in outdoor environments.

2. A method of fabricating a unitary kitchen assembly suitable for use outdoors comprising the steps of:
(a) tooling an expanded polystyrene member to have a plurality of circumferential surfaces, a plurality of interior surfaces and a plurality of recessed surfaces, the recessed surfaces comprising a compartment for accepting a stove element and the interior surfaces for accepting an element selected from the group consisting of shelves, refrigerators, warmers, drawers and storage space,
(b) insulating the compartment in the expanded polystyrene member such that the stove element, upon acceptance in the compartment, is sufficiently insulated with respect to the compartment to protect the heat integrity of the member at temperatures that the stove element operates, and
(c) at least one of the steps of:
(1) supporting the expanded polystyrene member with a plurality of elongated structural load point studs and
(2) coating the exterior of the member with a urethane/quartz aggregate
for providing structural integrity to the member such that the member can receive weighted objects thereupon without compromising the structural integrity of the expanded polystyrene member, such that the steps of tooling, insulating, supporting, coating result in a unitary kitchen assembly adaptable to be placed in outdoor environments.

3. A unitary kitchen assembly comprising:
(a) an expanded polystyrene member comprising
(1) a plurality of circumferential surfaces having a plurality of extremities remote one from the other,
(2) a plurality of interior surfaces, the interior surfaces for accepting an element selected from the group consisting of shelves, refrigerators, warmers, drawers and storage spaces, and
(3) a plurality of recessed surfaces, the recessed surfaces comprising a compartment for accepting a stove element,
(b) insulation for engaging the stove element and the compartment sufficient to protect the heat integrity of the member at temperatures that the stove element operates, and
(c) at least one of
(1) a plurality of structural load point supports extending through the expanded polystyrene member for providing structural integrity to the member, and
(2) a urethane/quartz aggregate exterior coating for supporting the expanded polystyrene member for providing structural integrity to the member such that the member can receive weighted objects thereupon without compromising the structural integrity of the expanded polystyrene member, whereby the unitary kitchen assembly is adaptable to be placed in outdoor environments.

4. The unitary kitchen assembly defined in claim 3 wherein the insulation for engaging the stove element and the compartment sufficient to protect the heat integrity of the member at temperatures that the stove element operates comprises:
(a) a first insulating partition for engaging the stove element,
(b) a second insulating partition for engaging the member, and
(c) an intermediate insulating partition congruent with the compartment for engaging the first insulating partition and the second insulating partition sufficient to protect the heat integrity of the member at temperatures that the stove element operates.

5. The unitary kitchen assembly defined in claim 3 wherein the structural load point support extending through the expanded polystyrene member comprises a plurality of stanchions engaged with the extremities of the member for providing the uniform support and distribution of the weight of any object placed on the member such that the member can receive weighted objects thereupon without compromising the structural integrity of the expanded polystyrene member.

6. The unitary kitchen assembly defined in claim 3 wherein the urethane/quartz aggregate exterior coating for supporting the expanded polystyrene member for providing structural integrity to the member comprises a diisocyanate diphenylmethane and a hydroxy polyol proportionately mixed and catalyzed into a spray that is applied simultaneously while broadcasting the quartz aggregate for providing the uniform support and distribution of the weight of any object placed on the member such that the member can receive weighted objects thereupon without compromising the structural integrity of the expanded polystyrene member.
